(19) United States
(12) Patent Application Publication
(10) Pub. No.: US 2026/0132821 A1
(43) Pub. Date: May 14, 2026

(54) ASSEMBLY TOOLING AND METHOD OF ASSEMBLING A PLAIN BEARING UNIT

(71) Applicant: SKF Aerospace France S.A.S, Perrigny (FR)

(72) Inventor: Alexandre BARTHOD, Saint-Julien (FR)

(21) Appl. No.: 19/380,085

(22) Filed: Nov. 5, 2025

(30) Foreign Application Priority Data
Nov. 13, 2024 (FR) FR2412378

(51) Int. Cl. F16C 43/02; F16C 23/04

(52) U.S. Cl. CPC F16C 43/02; F16C 23/046

(57) ABSTRACT

A plain bearing unit having an interior ring, an exterior ring and a sleeve is assembled by specific tooling. The tooling includes an assembly ring and an assembly shaft, the shaft having a first, frustoconical part and a second part for the assembly of the sleeve. To proceed with the assembly of the unit, the assembly shaft, on which a retention ring and the sleeve are positioned, is inserted into the bore of the interior ring on the side opposite the sleeve, by thrusting axially until the retention ring and the sleeve are inserted into two grooves provided in the bore of the interior ring and in the exterior surface of the sleeve, such that the unit is rendered integral or fixedly coupled.

### CROSS-REFERENCE

This application claims priority to French patent application no. 2412378 filed on Nov. 13, 2024, the contents of which are fully incorporated herein by reference.

### BACKGROUND OF THE INVENTION

The present invention relates to plain bearing units of the swivel joint type as used in the aeronautics industry, and more particularly to the assembly of such a plain bearing unit.

Typically, a plain bearing unit comprises an exterior ring provided with a spherical interior surface, and an interior ring provided with a spherical exterior surface.

In the aeronautics industry, these units are often installed on joints of the swivel type, in order to adapt to the deformations of the structures, which may be caused by expansion.

During maintenance operations, these joints need to be dismantled in order to release the unit. In order to facilitate assembly and dismantling, it is known for the interior ring to be able to be formed as a split ring, which is therefore may be produced in several parts.

However, during the maintenance operations, the several parts of the interior ring may cause marks to be formed on the shaft of the joint at the slot(s) of the interior ring, thus making necessary a costly replacement of the joints each time a dismantling takes place.

To eliminate this requirement, it is known to assemble an annular sleeve in the bore of the interior ring, in order to obtain a continuous cylindrical contact, without discontinuity, with the shaft of the joint.

In order to form a single unit which is easy to assemble and dismantle, the sleeve must be rendered integral or fixedly coupled with the interior ring.

In the prior art, several methods for assembly of the sleeve on the interior ring are known, including a method consisting of equipping the sleeve with an annular support at one end, assembled supported axially against one of the frontal faces of the interior ring, and with a thread at the other end, on which there is screwed a nut which is supported against the other frontal face of the interior ring.

However, these methods have certain disadvantages, such as additional parts and cost, and may be impractical since the sleeve, which has to act as a wear part, needs to be easy to replace and assemble in the interior ring during maintenance operations. Further, specific tooling for efficient assembly of a plain bearing unit of this type has not been known.

### SUMMARY OF THE INVENTION

The objective of the present invention is thus to eliminate the above-discussed disadvantages by providing a method for assembly of a plain bearing unit by means of assembly tooling.

The plain bearing unit comprises a swivel joint which is provided with an interior ring comprising a spherical exterior surface, and with an exterior ring comprising a spherical interior surface which is assembled on the spherical exterior surface of the interior ring, a sleeve provided with an exterior surface assembled in the bore of the interior ring of the swivel joint, and a radially resilient retention ring, which extends in the interior of a groove provided in the bore of the interior ring of the swivel joint, and in the interior of a groove provided on the exterior surface of the sleeve.

The assembly tooling comprises:
a cylindrical assembly ring provided at an axial end with a flange; and
an assembly shaft with a first part having a frustoconical form and a second assembly part of the sleeve, the assembly shaft being configured to be inserted into the bore of the interior ring of the swivel joint.

In addition, the frustoconical form of the first part of the assembly shaft can correspond to a stepped frustoconical form including a plurality of successive bearings along the axis of the first part of the shaft. Each bearing can have a distinct diameter:
the first bearing having a first diameter corresponding to the interior diameter of the retention ring in the free state;
the second bearing having a second diameter larger than the first diameter, and corresponding to the exterior diameter of the retention ring in a configuration of resilient deformation, which is smaller than the inner diameter of the bore of the interior ring; and
the third bearing having a third diameter larger than the first and second diameters, and smaller than the diameter of the bore of the sleeve.

In addition, the third bearing of the part of the assembly shaft can have a length which is at least equal to half the length of the sleeve.

Once the sleeve is inserted on the second part of the assembly shaft, the diameter of the exterior surface of the assembly part of the sleeve is smaller than, or the same as, the diameter of the bore of the interior ring of the swivel joint.

The diameter of the exterior surface of the assembly ring is designed to be smaller than, or the same as, the diameter of the bore of the interior ring of the swivel joint.

The invention also concerns a method for assembly of the plain bearing unit as previously defined, by means of assembly tooling. The method comprises the following steps:
a step of positioning of the retention ring on the first part of the assembly shaft;
a step of insertion of the sleeve on the second part of the assembly shaft;
a step of assembly of the interior ring of the swivel joint in the bore of the exterior ring;
a step of insertion of the assembly ring into the bore of the interior ring of the swivel joint, until the flange of the said ring abuts the interior ring;
a step of insertion of the first part of the assembly shaft equipped with the retention ring into the interior of the bore of the interior ring axially on the side opposite the sleeve;
a step of axial thrusting of the assembly shaft into the interior of the bore of the interior ring of the swivel joint, until the following is obtained:
abutment of the retention ring against the assembly ring, and insertion of the retention ring into the interior of the groove of the interior ring by resilient deformation; then
insertion of the said retention ring into the interior of the groove of the sleeve by resilient return, and rendering the sleeve and the interior ring of the swivel joint axially integral or fixed coupled axially.

Before the step of insertion of the first part of the shaft into the bore of the interior ring, a step is carried out of assembly of the interior ring in the exterior ring of the swivel joint.

Next, during the step of axial thrusting of the assembly shaft, the abutment ring is maintained as far as the abutment of the retention ring against the assembly ring, thus giving rise to sliding of the retention ring along the first part of the assembly shaft, and insertion of the retention ring into the interior of the groove of the interior ring, by deformation.

Thus, during the step of axial thrusting of the assembly shaft, and after the insertion of the retention ring into the groove of the interior ring, the assembly ring adheres to the first part of the said assembly shaft, and is released from the exterior ring.

Subsequently, the method continues with a step of withdrawal of the assembly shaft from the bore of the interior ring, once the sleeve and the interior ring have been rendered integral axially.

Thus, the sleeve and the swivel joint are rendered integral axially or fixedly coupled in a convenient manner by means of specific tooling.

### BRIEF DESCRIPTION OF THE SEVERAL VIEWS OF THE DRAWINGS

The present invention will be better understood by studying the detailed description of an embodiment, taken by way of example which is in no way limiting, and illustrated by the appended drawings, in which:

FIG. 1 is a view in cross-section of a plain bearing unit according to an embodiment of the invention;

FIG. 2 is a view in cross-section of the assembly tooling, more specifically of the assembly shaft on which there are inserted the sleeve and the retention ring in their successive positions; and

FIG. 3, FIG. 4, FIG. 5 and FIG. 6 are each a view in cross-section illustrating a separate step in the assembly of the plain bearing unit by means of the assembly tooling.

### DETAILED DESCRIPTION OF THE INVENTION

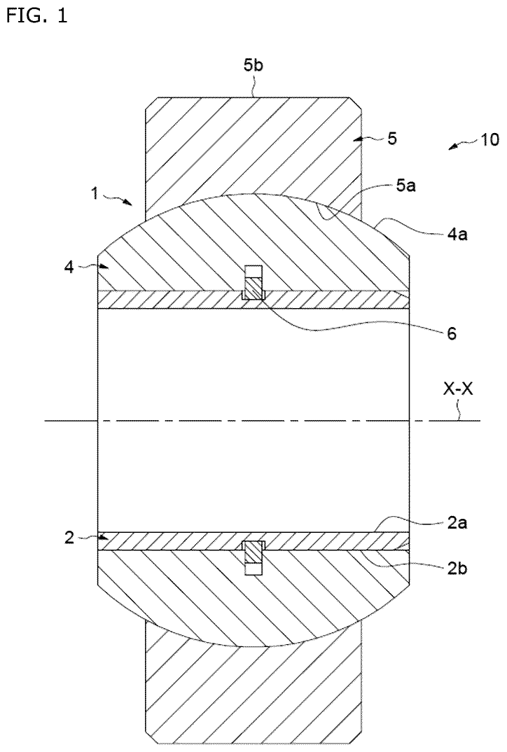

FIG. 1 represents a smooth bearing unit 10 with an axis X-X′, comprising a swivel joint 1 and a sleeve 2 mounted in the bore of the swivel joint.

As will be described in greater detail hereinafter, the unit 10 also comprises a retention ring 6 interposed radially between the swivel joint 1 and the sleeve 2, in order to ensure that they are rendered integral axially.

The swivel joint 1, with an axis X-X′, comprises an interior ring 4 and an exterior ring 5 fitted on the interior ring 4. The interior and exterior rings 4, 5 are each made of steel, titanium, nickel alloy, bronze, etc.

The interior ring 4 is provided with a convex spherical exterior surface 4a, a cylindrical bore 4b radially opposite the exterior surface 4a, and two opposite radial frontal faces (not indicated) axially delimiting the bore 4b and the exterior surface 4a.

The interior ring 4 may be produced in several parts which are supported against one another to form the ring 4. The interior ring 4 may be split along one or more planes passing via the axis X-X′. The interior ring 4 may also be formed as a single piece.

The exterior ring 5 is provided with a concave spherical interior surface 5a, fitted on the spherical exterior surface 4a of the interior ring 4, with a cylindrical exterior surface 5b, radially opposite the interior surface 5a, and with two opposite radial frontal faces (no indicated) axially delimiting the interior and exterior surfaces 5a, 5b. The interior surface 5a of the exterior ring 5 and the exterior surface 4a of the interior ring 4, have a complimentary form or are formed complementary to each other. The exterior ring 5 may have a solid spherical form or it can be produced in two parts, and/or may also include notches on its exterior surface 5b.

A groove 44 is formed in the bore 4b of the interior ring of the swivel joint 1. The groove 44 is oriented radially towards the interior, i.e. in the direction of the sleeve 2. The groove 44 is radially facing a groove 22 of the sleeve 2, which will be described in greater detail hereinafter. Preferably, the groove 44 is annular and is delimited in the radial direction by two facing radial walls (not indicated) which are connected to one another by a base wall. The base wall of the groove 44 is offset radially toward the exterior in relation to the bore 4b of the interior ring 4. In the embodiment illustrated, the groove 44 has an axial width which is reduced in relation to the width of the groove 22. Alternatively, the groove 44 may have an axial width which is greater than, or the same as, that of the groove 22.

The sleeve 2 is mounted in the bore 4b of the interior ring 4 which forms the bore of the swivel joint 1. The sleeve 2, with an axis X-X′, has an annular form.

The sleeve 2 is provided with a convex cylindrical exterior surface 2b mounted in the bore 4b of the interior ring 4 of the swivel joint 1, with a cylindrical bore 2a radially opposite the exterior surface 2b, and with two radially opposite frontal faces (not indicated) axially delimiting the bore 2a and the exterior surface 2b.

The groove 22 is formed on the exterior surface 2b of the sleeve 2. The groove 22 is oriented radially toward the exterior, i.e. in the direction of the interior ring 4 of the swivel joint 1. The groove 22 is preferably annular and delimited in the radial direction by two facing radial walls (not indicated) which are connected to one another by a base wall. The base wall of the groove 22 is offset radially toward the interior in relation to the exterior surface 2b of the sleeve 2.

As previously indicated, the unit 10 also comprises the retention ring 6, in order to ensure that the swivel joint 1 and the sleeve 2 are rendered axially integral or axially fixedly coupled. The retention ring 6 is radially resilient; in other words, the retention ring 6 is resiliently deformable in the radial direction. The retention ring 6 extends into the interior of the grooves 22, 44 of the sleeve 2 and the interior ring 4, respectively, of the swivel joint 1.

The axial thickness of the retention ring 6 is slightly smaller or less than the axial width of the groove 44 of the interior ring 4 of the swivel joint 1, and less than that of the groove 22 of the sleeve 2. The radial depth of the groove 44 is larger or greater than the radial thickness of the retention ring 6.

The retention ring 6 may be open at a point of the circumference of the ring 6. The retention ring 6 may be in the form of a circlip made of a metallic material. Alternatively, the retention ring 6 can be produced from synthetic material (e.g., a polymer).

In a free state, the retention ring 6 has an exterior diameter which is smaller or less than the diameter of the bore 4b of the interior ring 4 of the swivel joint, and smaller/less than the diameter of the groove 44. The diameter of the groove 44 is taken at the level of its base wall. Preferably, there is a radial gap between the retention ring 6 and the base wall of the groove 44.

In the free state, the retention ring 6 has an interior diameter which is smaller or less than the diameter of the exterior surface 2a of the sleeve 2. In the illustrated embodiment, in a free state, the interior diameter of the retention ring 6 is less than, or the same as, the interior diameter of the groove 22. The interior diameter of the groove 22 is taken at the level of its base wall. The retention ring 6 is supported radially against the base wall of the groove 22. As a variant, in the free state, the interior diameter of the retention ring 6 may be greater than the diameter of the groove 22, while however remaining less than the diameter of the exterior surface 2a of the sleeve 2.

In the embodiment illustrated, the retention ring 6 has a rectangular form in straight cross-section. Alternatively, the retention ring 6 may have other forms in straight cross-section, for example, square or circular.

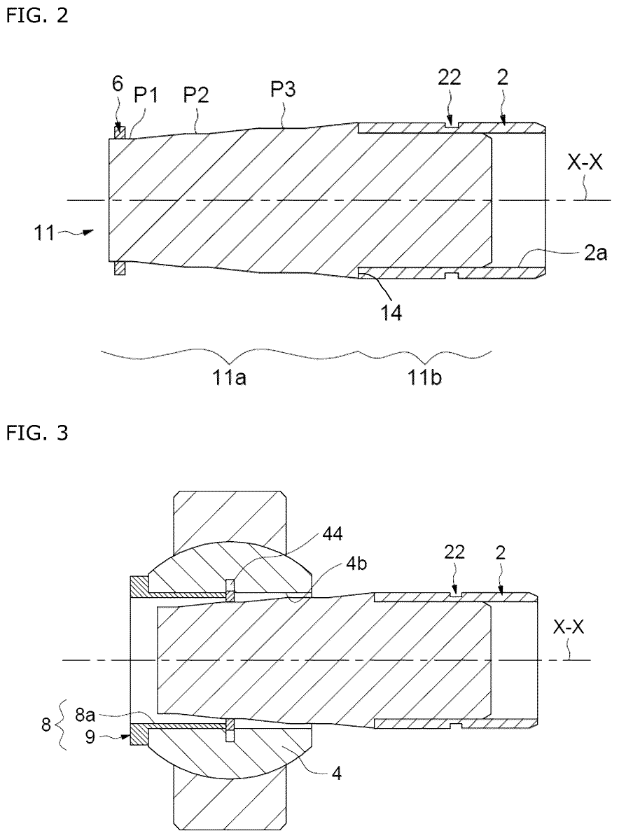

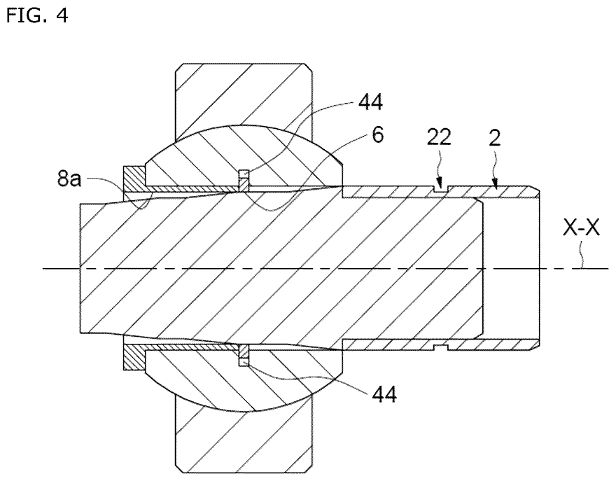

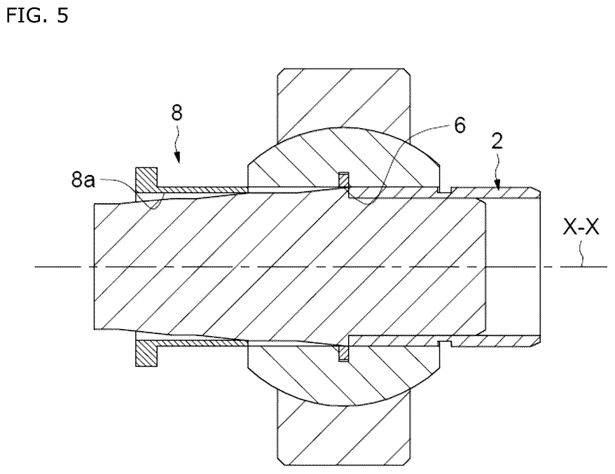

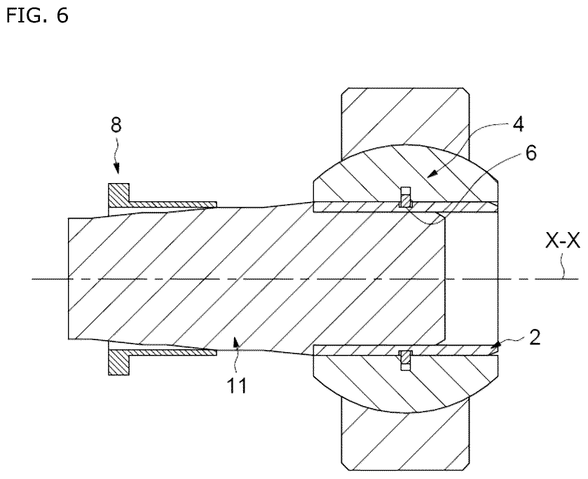

FIG. 2 and FIG. 3 represent more clearly the assembly tooling used for the assembly of the unit 10 as previously described.

The assembly shaft 11 is a component which is cylindrical of revolution, i.e., is generally cylindrical, and which, in the free state, is composed of two sections with different diameters delimiting two assembly parts 11a and 11b, intended for the insertion respectively of the retention ring 6 and the sleeve 2.

The first part 11a of the assembly shaft 11 has a frustoconical form or shape, which can advantageously be a stepped frustoconical form marked by distinct cylindrical bearings or bearing surfaces P1, P2, P3 with diameters which increase along the axis of the part 11a of the assembly shaft 11. Such a configuration makes it possible in particular to control the adjustment of the retention ring 6 to the different sized bearings, and to facilitate the progressive insertion of the retention ring 6 into the groove 44 of the bore 4b of the interior ring 4, during a step of axial thrust (i.e., thrusting axially) of the assembly shaft 11.

As shown in FIG. 2, each bearing P1, P2, P3 of the first part 11a of the assembly shaft 11 thus has a distinct diameter corresponding to the positioning of the retention ring 6 during the steps of assembly of the plain bearing unit 1.

On the first bearing P1, the end of the assembly part 11a has a first diameter corresponding to the interior diameter of the retention ring 6 in the free state. This permits effortless positioning of the ring 6 on the assembly shaft 11.

On the second bearing P2, the part 11a of the assembly shaft has a second diameter which is larger than the first diameter of the bearing P1, corresponding to the exterior diameter of the ring 6 in a resilient deformation configuration. The second diameter is smaller or less than the inner diameter of the bore 4b of the interior ring 4. By this means, it is possible for the ring 6, positioned on the part 11a of the assembly shaft, to be inserted into the bore 4b of the interior ring 4.

On the third bearing P3, the first part 11a of the assembly shaft 11 has a third diameter which is larger than the first and second diameters of the bearings P1 and P2, respectively, and is greater than the diameter of the bore 2b of the sleeve 2. At this stage, the retention ring 6 is partly accommodated in the groove 44 of the interior ring 4.

In addition, the third bearing 3 of the part 11a of the assembly shaft 11 may have a length which is at least equal to half the length of the sleeve 2, so as to permit in the first stage the insertion of the retention ring 6 into the groove 44 of the interior ring 4, and then a release of the assembly ring 8 from the bore 4b of the interior ring 4.

The dimensioning of the bearing 3 of the first part 11a of the shaft 11 contributes towards maintaining the retention ring 6 in place, when the assembly shaft 11 is inserted into the bore 4b of the interior ring 4 during the assembly, and to progressive transition between the state of deformation of the ring 6 and its insertion into the groove 44 of the interior ring 4.

Similarly, the length of the bearing 3 of the first part 11a of the shaft 11 also allows the assembly ring 8 to be released from the bore 4b of the interior ring 4 only after the insertion of the retention ring 6 into the groove 44 of the interior ring 4.

If the length of the bearing 3 is too short, there can be both a risk of the assembly ring 8 being disengaged too early, i.e. before the ring 6 has been completely inserted into the groove 44 of the interior ring 4, and of the transition, by resilient return, between the deformed state of the ring on the part 11a of the assembly shaft 11, and its insertion into the groove 44, being sudden, with the risk of damaging the precision of the unit 10.

Furthermore, the assembly shaft 11, and in particular the first part 11a of the assembly shaft, has dimensions such as to have a length sufficient to permit the insertion of the retention ring 6 before the disengagement of the assembly shaft 8 from the bore 4b of the interior ring 4.

As illustrated in FIG. 2, the retention ring 6 is designed to be positioned on the first part 11a of the shaft 11, and to slide radially by resilient deformation along the first part 11a of the assembly shaft 11, passing subsequently or successively via the bearings P1, P2, P3, thus permitting controlled and easy insertion of the ring 6 into the groove 44 of the interior ring 4.

The second part 11b of the assembly shaft 11 corresponds to an assembly part of the sleeve 2. The second part 11b of the shaft 11 is axially opposite the part 11a.

The second part 11b of the assembly shaft 11 may be provided with a shoulder 14, permitting abutment of the sleeve 2 on the assembly shaft 11. The sleeve 2 is thus inserted onto the second part 11b of the assembly shaft 11 until the sleeve 2 abuts the shoulder 14, thus enabling precise positioning and adjustment of the sleeve 2 on the assembly shaft 11. Among other things, the shoulder 14 prevents disengagement of the sleeve 2 from the assembly shaft 11, by limiting the axial movement of the sleeve 2 during assembly steps which will be described in greater detail hereinafter.

The outer diameter of the sleeve 2 is smaller or less than, or the same as, the diameter of the bore 4b of the interior ring 4 of the swivel joint 1. The outer diameter of the sleeve 8 is the same as a large or greatest diameter of the first part 11a of the shaft 11.

FIG. 3 shows the assembly ring 8. The assembly ring 8 has a hollow cylindrical body provided at one axial end with a flange 9. The assembly ring 8 has an exterior surface 8b with a diameter that is smaller than, or the same as, the diameter of the bore 4b of the interior ring 4 of the swivel joint 1. Preferably, the exterior surface 8b of the assembly ring 8 is in contact with the bore 4b of the interior ring 4. This contact permits close adjustment of the assembly ring 8 when the ring 8 is inserted into the bore 4b of the interior ring 4. Thus, the diameter of the interior surface 8a of the assembly ring 8 is smaller or less than the diameter of the bore 4b of the interior ring 4 of the swivel joint 1.

In addition, the assembly ring 8 is dimensioned so as to leave the groove 44 of the interior ring 4 free, when the assembly ring 8 is inserted into the bore 4b of the interior ring 4, after the step of assembling the interior ring 4 into the bore 5a of the exterior ring 5.

An axial end of the assembly ring 8 is thus flush with a radial wall of the groove 44 which is situated axially on an opposing axial side from the flange 9. As a result of this configuration, the assembly ring 8 abuts the retention ring 6 during the insertion of the assembly shaft 11 into the bore 4b of the interior ring 4 of the swivel joint 1.

The flange 9 of the assembly ring 8 forms a rim or a contact surface which extends from the exterior diameter of the assembly ring 8, thus making the flange 9 abut an axial end of the interior ring 4 of the swivel joint 1, when the assembly ring 8 is inserted into the bore 4b of the interior ring 4 of the swivel joint 1, in a configuration as shown in figures FIG. 3, FIG. 4 and FIG. 5.

In order to assemble the unit 10 by means of the assembly tooling as described above, the assembly process is as follows.

In a first stage, a step is carried out of preparation of the assembly tooling. During this step, the retention ring 6 is positioned on the first bearing P1 of the first part 11a of the assembly shaft 11, the sleeve 2 is inserted on the second part 11b of the shaft 11, and the assembly ring 8 is inserted into the interior ring 4 of the swivel joint 1 until the flange 9 abuts an axial end of the interior ring 4.

Once the tooling has been arranged in an assembly configuration as shown in FIG. 3, and before the step of insertion of the assembly ring 8 into the bore 4b of the interior ring 4, a step of assembling the interior ring 4 into the bore 5b of the exterior ring 5 is carried out.

Then, as illustrated in FIG. 4 and FIG. 5, the first part 11a of the assembly shaft, axially opposite the second part 11b of the shaft 11 on which the sleeve 2 is positioned, is inserted into the bore 4b of the interior ring 4. During this axial thrusting step, the assembly ring 8 is retained in order for the retention ring 6 to abut the cylindrical body 8a of the assembly ring 8. By this means, during the axial thrusting step, the retention ring 6 abutting the cylindrical body 8a of the assembly ring 8 will be slidingly driven by resilient deformation of the first part 11a of the assembly shaft 11, passing in succession via the bearings P1, P2 and P3 as previously described. In fact, at each axial thrust of the assembly shaft 11, a force is applied in order to thrust the shaft 11 through the bore 4b of the interior ring 4. By maintaining the assembly ring 8 abutting the ring 6, this force of the assembly shaft 11 is transmitted to the abutment of the assembly ring 8, which will force the retention ring 6 to slide along the first part 11a of the shaft 11, adapting or expanding its diameter to the different bearings P1 to P3 by resilient deformation. The abutment of the assembly ring 8 also makes it possible to ensure that the ring 6 is retained along the first part 11a of the assembly shaft 11, thus preventing premature disengagement until it is progressively inserted into the groove 44 of the interior ring 4. Thus, by means of the abutment of the retention ring 6 during the axial thrusting of the assembly shaft 11, the assembly ring 8 drives the ring 6 to slide along the first part 11a of the shaft 11, passing the bearings P1 to P3 in succession, until the ring 6 is inserted into the groove 44 of the interior ring 4.

The step of axial thrusting of the shaft 11 is then continued, and at this stage, the retention ring 6, positioned at the third bearing P3 of the part 11a of the assembly shaft 11, is already partly accommodated in the groove 44, sufficiently to block axial movement of the interior ring 4.

Finally, the step of axially thrusting the assembly shaft 11 into the interior of the bore 4b of the interior ring 4 is continued, until the retention ring 6 is inserted into the interior of the groove 22 of the sleeve 2, by resilient return, when the grooves 22 and 44 are opposite one another and axially aligned, and the sleeve 2 and the interior ring 4 of the swivel joint 1 are rendered integral axially or fixedly coupled axially.

In addition, once the assembly tooling 8, 11 has been removed, a step of verification may be carried out to ensure that the retention ring 6 is correctly positioned in the aligned grooves 22, 44 provided respectively on the exterior surface 2a of the sleeve 2 and in the bore 4b of the interior ring 4 of the swivel joint 1. In order to verify that the sleeve 2 and the interior ring 4 have been rendered integral axially/fixedly coupled, the sleeve 2 is pulled in both axial directions, so as to ensure that the unit 10 cannot be dismantled. Optionally, an axial gap may be tolerated during assembly of the sleeve 2 and the interior ring 4 of the swivel joint 1. This gap enables a limited axial displacement of the sleeve 2 relative to the bore 4b of the interior ring 4 of the swivel joint 1.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A method for assembling a plain bearing unit by means of assembly tooling, the plain bearing unit including a swivel joint provided with an interior ring having a spherical exterior surface, and an exterior ring having a spherical interior surface assembled on the spherical exterior surface of the interior ring, a sleeve having an exterior surface assembled in a bore of the interior ring of the swivel joint, and a radially resilient retention ring extending into the interior of a groove provided in the bore of the interior ring of the swivel joint and in the interior of a groove provided on the exterior surface of the sleeve, the tooling including an assembly ring having a flange provided at an axial end of the assembly ring and an assembly shaft with a first part having a frustoconical form and a second part of the sleeve, the assembly shaft being configured to be inserted into the bore of the interior ring of the swivel joint, the method comprising the steps of:
positioning the retention ring on the first part of the assembly shaft;
inserting the sleeve on the second part of the assembly shaft;
assembling the interior ring of the swivel joint within the bore of the exterior ring;
inserting the assembly ring into the bore of the interior ring of the swivel joint until the flange of the assembly ring abuts the interior ring;
inserting the first part of the assembly shaft equipped with the retention ring into the interior of the bore of the interior ring axially on the side opposite the assembly ring; and
axially thrusting the assembly shaft into the interior of the bore of the interior ring of the swivel joint until the retention ring abuts against the assembly ring, the retention ring is inserted into the interior of the groove of the interior ring by resilient deformation and then the retention ring is inserted into the interior of the groove of the sleeve by resilient return so as to axially fixedly couple the sleeve and the interior ring of the swivel joint.

2. The assembly method according to claim 1, wherein the step of assembling the interior ring in the exterior ring is carried out before the step of inserting the assembly ring into the bore of the interior ring.

3. The assembly method according to claim 2, wherein, during the step of axially thrusting the assembly shaft, the assembly ring is retained until the retention ring abuts the assembly ring such that the retention ring slides thereafter along the first part of the assembly shaft until the retention ring is inserted into the interior of the groove of the interior ring by resilient return.

4. The assembly method according to claim 3, wherein, during the step of axially thrusting the assembly shaft and after insertion of the retention ring into the groove of the interior ring, the assembly ring adheres to the first part of the assembly shaft and is released from the bore of the interior ring.

5. The assembly method according to claim 1, further comprising a step of withdrawing the assembly shaft from the bore of the interior ring, after the sleeve and the interior ring have become axially fixedly coupled.

6. Tooling for implementation of the assembly method according to claim 1, the tooling comprising:
an assembly ring having an axial end and a flange at an opposing axial end; and
an assembly shaft with a first part having a frustoconical form and a second part having a cylindrical form for receiving the sleeve.

7. The tooling according to claim 6, wherein the first part of the assembly shaft has a stepped frustoconical form including a plurality of bearings successively located along an axis of the assembly shaft, and wherein:
the first bearing has a first diameter corresponding to an interior diameter of the retention ring in a free state;
the second bearing has a second diameter greater than the first diameter and corresponding to an exterior diameter of the retention ring in a configuration of resilient deformation, which is less than an inner diameter of the bore of the interior ring; and
the third bearing has a third diameter greater than the first and second diameters, and greater than a diameter of the bore of the sleeve.

8. The tooling according to claim 7, wherein the third bearing of the first part of the assembly shaft has an axial length which is equal to at least half of an axial length of the sleeve.

9. The tooling according to claim 6, wherein the sleeve has an exterior diameter which is less than or equal to an interior diameter of the bore of the inner ring of the swivel joint.

10. The tooling according to claim 6, wherein a diameter of an interior surface of the assembly ring is less than a diameter of the bore of the interior ring of the swivel joint.
